(19) United States
(12) Patent Application Publication
(10) Pub. No.: US 2004/0146012 A1
(43) Pub. Date: Jul. 29, 2004

(54) Transmitters, method of detecting available node number and method of generating topology data

(76) Inventors: Kouichirou Houjyou, Yokohama (JP); Naohiro Kato, Yokohama (JP); Akira Inaba, Yokohama (JP); Takashi Aso, Mobara (JP); Hironobu Kurumazaki, Yokohama (JP)

Correspondence Address: KATTEN MUCHIN ZAVIS ROSENMAN, 575 MADISON AVENUE, NEW YORK, NY, 10022-2585, US

(21) Appl. No.: 10/728,362

(22) Filed: Dec. 2, 2003

(30) Foreign Application Priority Data
Jan. 7, 2003 (JP) 2003-000960

(51) Int. Cl. H04L 12/28

(52) U.S. Cl. 370/255; 370/258

(57) ABSTRACT

A transmitter, a method of detecting an available node number, and a method of generating topology data are disclosed for a ring type network. The transmitter in a ring type network includes a packet generation and transmission part generating a packet to cause other transmitters in the ring type network to set node numbers assigned to the transmitters and circulating the packet in the ring type network, and a node number detection part, in response to receipt of the circulated packet, reading the node numbers from the packet and detecting an available node number with reference to the read node numbers. According to the present invention, it is possible to maintain and operate a ring type network with less operation steps to improve a maintenance and operation speed.

### CROSS-REFERENCE TO RELATED APPLICATIONS

The present application is based on Japanese priority application No. 2003-000960 filed Jan. 7, 2003, the entire contents of which are hereby incorporated by reference.

### BACKGROUND OF THE INVENTION

1. Field of the Invention

The present invention is related to a transmitter, a method of detecting an available node number, and a method of generating topology data, and particularly to a transmitter connected to a ring type network, and a method of detecting an available node number in a ring type network, and a method of generating topology data in a ring type network.

2. Description of the Related Art

In a typical ring type network, a plurality of distributed nodes are connected in a ring-shaped configuration via a communication cable, which is called a bus, such as an optical cable and a metallic cable. In such a ring type network, a certain identification number, which is referred to as a node number hereinafter, is assigned to each node in the ring type network in advance.

A description is given, with reference to FIG. 1 through FIG. 4, of an exemplary ring type network in which a plurality of distributed transmitters, which are embodiments of nodes in the ring type network, are connected.

FIG. 1 shows an exemplary system structure of such a ring type network in which a plurality of distributed transmitters are connected.

Referring to FIG. 1, the ring type network of the ring number 1, in which a plurality of distributed transmitters (NE) 10a through 10f are connected, is provided. The ring number means an identification number to identify each ring type network.

Local workstations (LWS) 14 are connected to the individual transmitters 10a through 10f as illustrated in FIG. 1. For each of the transmitters 10a through 10f, the corresponding LWS 14 is used to set the ring number, the node number and other data of the transmitter.

In particular, the transmitter 10a, which is often called an anchor NE, is connected to a monitor control operation system (NE-OpS) 12. The monitor control operation system 12 has topology data as illustrated in FIGS. 2A and 2B.

FIGS. 2A and 2B show exemplary data structures of such topology data.

Referring to FIGS. 2A and 2B, topology data are generated for each of two directional transmission paths, that is, for each of an east direction (clockwise direction) and a west direction (counterclockwise direction) of the ring type network as illustrated in FIG. 1. The topology data shown in FIGS. 2A and 2B can include at most 16 transmitters.

FIG. 2A shows exemplary topology data of the west directional (counterclockwise) transmission path. Beginning with the transmitter 10a, the topology data are configured along the west directional transmission path in the order of the transmitters 10a, 10b, 10c, 10d, 10e and 10f. In such topology data, a node number, an NE status, a GW attribute, and other data items may be typically stored for each of the transmitters 10a through 10f.

Specifically, the topology data shown in FIG. 2A represents a ring type network including the transmitters 10a, 10b, 10c, 10d, 10e and 10f to which respective node numbers NE#a, NE#b, NE#c, NE#d, NE#e and NE#f are assigned.

On the other hand, FIG. 2B shows exemplary topology data of the east directional (clockwise) transmission path. Beginning with the transmitter 10a, the topology data are configured along the east directional transmission path in the order of the transmitters 10a, 10f, 10e, 10d, 10c and 10b. In such topology data, a node number, an NE status, a GW attribute, and other data items may be typically stored for each of the transmitters 10a through 10f.

Specifically, the topology data shown in FIG. 2B represents a ring type network including the transmitters 10a, 10f, 10e, 10d, 10c and 10b to which respective node numbers NE#a, NE#f, NE#e, NE#d, NE#c and NE#b are assigned.

It is noted that the NE status represents a status, such as operational, maintenance closed and trouble, of each of the transmitters 10a through 10f, and the GW attribute indicates whether or not each of the transmitters 10a through 10f is connected to another ring type network.

In order to newly configure a ring type network, a ring type network generation operation as illustrated in FIG. 3 is performed.

FIG. 3 is an exemplary flowchart of the ring type network generation operation.

Referring to FIG. 3, a ring type network as illustrated in FIG. 1, in which transmitters 10a through 10f are connected via a communication cable, is configured at step S11.

At step S12, LWSs 14, to which the individual transmitters 10a through 10f are connected, assign a node number to each of the transmitters 10a through 10f.

At step S13, the monitor control operation system 12, which is connected to the anchor transmitter 10a, sets topology data as illustrated in FIGS. 2A and 2B through a maintenance command.

At step S14, the monitor control operation system 12 establishes an in-channel connection (ICC), which serves as a control path, to each of the transmitters 10a through 10f so as to perform maintenance operations such as connection, deletion, and other operations of involved paths.

In order to add another transmitter to a currently operating ring type network, a conventional transmitter addition operation as illustrated in FIG. 4 is performed.

FIG. 4 is an exemplary flowchart of the transmitter addition operation. Through execution of the transmitter addition operation, it is possible to properly add a new transmitter to a currently operating ring type network without affecting services, which are currently being provided to the ring type network, by changing the statuses of transmitters adjacent to the newly added transmitter with respect to the east and west directions into a self-loop back condition.

Referring to FIG. 4, the monitor control operation system 12 accepts a loop back setting instruction at step S21. In response to receipt of the loop back setting instruction, the monitor control operation system 12 converts the received loop back setting instruction into a control command, and sends the control command to transmitters, which are referred to as target transmitters hereinafter, adjacent to the transmitter to be newly added.

At step S22, the target transmitters, in response to receipt of the control command from the monitor control operation system 12, determine whether or not the control command is normal, and then perform a self-loop back setting operation on themselves.

At step S23, after the target transmitters become a self-loop back status, each of the target transmitters sends a response for the received control command to the monitor control operation system 12.

At step S24, the monitor control operation system 12, in response to receipt of the command response from the target transmitters, adds the new transmitter in the ring type network by performing the above-mentioned step S12, alternatively, or other proper operations.

At step S25, the monitor control operation system 12 accepts a self-loop back release instruction. In response to receipt of the self-loop back release instruction, the monitor control operation system 12 converts the accepted self-loop back release instruction as a control command, and then sends the control command to the target transmitters.

At step S26, each of the target transmitters, in response to receipt of the control command from the monitor control operation system 12, determines whether or not the control command is normal, and then performs a self-loop back release operation.

At step S27, after the target transmitters are released from the self-loop back status, the target transmitters send a response for the received control command to the monitor control operation system 12.

At step S28, the monitor control operation system 12, in response to receipt of the response from the target transmitters, establishes ICC to the newly added transmitter by performing the above-mentioned step S14, alternatively, or other operations for the purpose of maintenance operations such as connection, deletion and other operations for involved paths.

Conventionally, LWS 14 is used in a ring type network to assign node numbers to each of the transmitters 10a through 10f. For example, Japanese Laid-Open Patent Application No. 05-276180 discloses a ring type network that realizes unique node numbering to individual transmitters in the ring type network by circulating a node number reference packet and a node number notification packet in the ring type network.

In such a ring type network, it is sufficient that LWSs 14 have only a function to assign ring numbers or node numbers to the individual transmitters 10a through 10f in the ring type network. Accordingly, the LWSs 14 are not conventionally required to share database to maintain the node numbers assigned to the transmitters 10a through 10f.

For this reason, some problems may occur when a ring type network is newly formed in accordance with the above-mentioned conventional ring type network generation method.

First, an administrator manipulates LWSs 14 to assign node numbers to the transmitters 10a through 10f in the ring type network. As a result, there is a risk that the same node number may be assigned to some of the transmitters 10a through 10f.

In addition, when the same node number is assigned to the transmitters, there is a risk that the node number duplication cannot be observed until ICCs are established to the transmitters in the ring type network.

Furthermore, the monitor control operation system 12 is not allowed to reassign node numbers or delete the duplicated node number until the ICCs are established. As a result, the administrator needs to visit the transmitters and reassign unique node numbers to the individual transmitters.

Conventionally, since the administrator is also responsible to set topology data as illustrated in FIG. 2 for the monitor control operation system 12, there is a risk that the topology data may be erroneously set.

In recent years, there has been a growing demand that transmitters can be more conveniently maintained and operated with fewer steps to address trouble more quickly. For this demand, when one or more of the above-mentioned problems occur, it is necessary to decrease the number of operation steps to address the problems.

Meanwhile, some other problems may occur when a transmitter is newly added to a currently operating ring type network in accordance with the above-mentioned conventional transmitter addition method.

First, similarly to the above-mentioned problems on formation of a new ring type network, when a transmitter is newly added to a ring type network, there is a risk that the same node number may be assigned to some transmitters in the ring type network or topology data on the ring type network may be erroneously set. Furthermore, there is an additional problem in that it is impossible to easily determine an available node number for the transmitter to be newly added.

As mentioned above, LWSs 14 in the ring type network do not necessarily share database to maintain node numbers assigned to individual transmitters in the ring type network. For this reason, it is impossible to comprehend an available node number in an on-demand fashion.

According to Japanese Laid-Open Patent

Application No. 05-276180, a plurality of the same node number reference packets and the same node number notification packets, whose number of respective packets is equal to the number of nodes in a ring type network, are circulated in the ring type network. As a result, there is a risk that packet duplication may occur.

### SUMMARY OF THE INVENTION

It is a general object of the present invention to provide a transmitter, a method of detecting an available node number, and a method of generating topology data in which one or more of the above-mentioned problems are eliminated.

A more specific object of the present invention is to provide a transmitter, a method of detecting an available node number, and a method of generating topology data whereby a ring type network can-be more conveniently maintained and operated with fewer operation steps to improve a maintenance and operation speed.

In order to achieve the above-mentioned objects, there is provided according to one aspect of the present invention a transmitter connected to a ring type network, including: a packet generation and transmission part generating a packet to cause at least one other transmitter in the ring type network to set a node number assigned to the at least one other transmitter in the packet and circulating said packet in the ring type network; and a node number detection part, in response to receipt of the circulated packet, reading at least one node number set by the at least one other transmitter from the packet and detecting an available node number that is not assigned to the at least one other transmitter with reference to the at least one read node number.

Additionally, there is provided according to another aspect of the present invention a transmitter connected to a ring type network, including: a packet generation and transmission part generating a packet to cause at least one other transmitter in the ring type network to set a node number assigned to the at least one other transmitter in the packet, and circulating said packet in the ring type network; and a duplicated node number detection part, in response to receipt of the circulated packet, reading at least node number set by the at least one other transmitter from the packet, and determining whether or not any of the at least one read node number and a self-node number of the transmitter are the same.

In an embodiment of the present invention, the transmitter may further include a self-node number setting and transmission part, in response to receipt of the packet generated by another transmitter in the ring type network, setting a self-node number of the transmitter in the packet, and sending the packet to another transmitter in the ring type network.

In an embodiment of the present invention, the self-node number setting and transmission part may read a ring number to identify the ring type network from the received packet; when the ring number and a ring number of a ring type network to which the transmitter belongs are the same, the self-node number setting and transmission part may set the self-node number in the packet and send the packet to the another transmitter; and on the other hand, when the ring number and the ring number of the ring type network to which the transmitter belongs are not the same, the self-node number setting and transmission part may send the packet to the another transmitter without setting the self-node number in the packet.

According to one aspect of the present invention, it is possible to easily detect an available node number in a ring type network by examining node numbers assigned to other transmitters in the ring type network. In addition, one packet is generated and circulated in the ring type network to detect an available node number. For this reason, it is possible to detect an available node number with less work load on the ring type network. Thus, it is possible to maintain and operate a ring type network with less operation steps to improve a maintenance and operation speed.

Additionally, there is provided according to another aspect of the present invention a transmitter connected to a ring type network, including: a packet generation and transmission part generating a packet to cause at least one other transmitter in the ring type network to set a node number assigned to the at least one other transmitter in the packet, and circulating said packet in the ring type network; and a topology data generation part, in response to receipt of the circulated packet, reading at least one node number set by the at least one other transmitter from the packet, and generating topology data regarding the ring type network based on the at least one node number.

In an embodiment of the present invention, the transmitter may further include: a topology data transmission part generating a packet including the generated topology data and circulating the packet in the ring type network; and a topology data reflection part, in response to receipt of the packet, reading the topology data from the packet and reflecting the topology data to a database of the transmitter.

In an embodiment of the present invention, the topology data reflection part: may read a target node number from the packet; and when the target node number and a self-node number of the transmitter are the same, may read the topology data from the packet and reflect the topology data to the database.

In an embodiment of the present invention, the topology data reflection part: may read a ring number to identify the ring type network from the received packet; and when the ring number and a ring number of a ring type network to which the transmitter belongs are the same, may read the topology data from the packet and reflect the topology data to the database.

According to one aspect of the present invention, it is possible to easily generate topology data regarding a ring type network by examining node numbers assigned to other transmitters in the ring type network. In addition, it is possible to generate the topology data with less work load on the ring type network. Thus, it is possible to maintain and operate a ring type network with less operation steps to improve a maintenance and operation speed.

Additionally, there is provided according to another aspect of the present invention a method of detecting an available node number that is not assigned to any of at least one transmitter in a ring type network, the method including the steps of: generating a packet to cause the at least one transmitter in the ring type network to set a node number assigned to the at least one other transmitter in the packet and circulating said packet in the ring type network; and reading, in response to receipt of the circulated packet, at least one node number set by the at least one transmitter from the packet and detecting the available node number with reference to the at least one read node number.

Additionally, there is provided according to another aspect of the present invention a method of determining whether there is an duplicated node number in a ring type network, the method including the steps of: generating a packet to cause at least one transmitter in the ring type network to set a node number assigned to the at least one transmitter in the packet, and circulating said packet in the ring type network; and reading, in response to receipt of the circulated packet, at least node number set by the at least one transmitter from the packet and determining whether or not any of the at least one read node number and any of at least one self-node number of the at least one transmitter are the same.

According to one aspect of the present invention, it is possible to easily detect an available node number in a ring type network by examining node numbers assigned to transmitters in the ring type network. In addition, one packet is generated and circulated in the ring type network to detect an available node number. For this reason, it is possible to detect an available node number with less work load on the ring type network. Thus, it is possible to maintain and operate a ring type network with less operation steps to improve a maintenance and operation speed.

Additionally, there is provided according to another aspect of the present invention a method of generating topology data regarding a ring type network including at least one transmitter, the method including the steps of: generating a packet to cause the at least one transmitter in the ring type network to set a node number assigned to the at least one transmitter in the packet and circulating said packet in the ring type network; and reading, in response to receipt of the circulated packet, at least one node number set by the at least one transmitter from the packet and generating the topology data regarding the ring type network based on the at least one node number.

According to one aspect of the present invention, it is possible to easily generate topology data regarding a ring type network by examining node numbers assigned to other transmitters in the ring type network. In addition, it is possible to generate the topology data with less work load on the ring type network. Thus, it is possible to maintain and operate a ring type network with less operation steps to improve a maintenance and operation speed.

Other objects, features and advantages of the present invention will become more apparent from the following detailed description when read in conjunction with the accompanying drawings.

### BRIEF DESCRIPTION OF THE DRAWINGS

FIG. 1 is a diagram illustrating an exemplary system structure of a ring type network in which a plurality of distributed transmitters are connected;

FIGS. 2A and 2B are diagrams illustrating exemplary data structures of topology data;

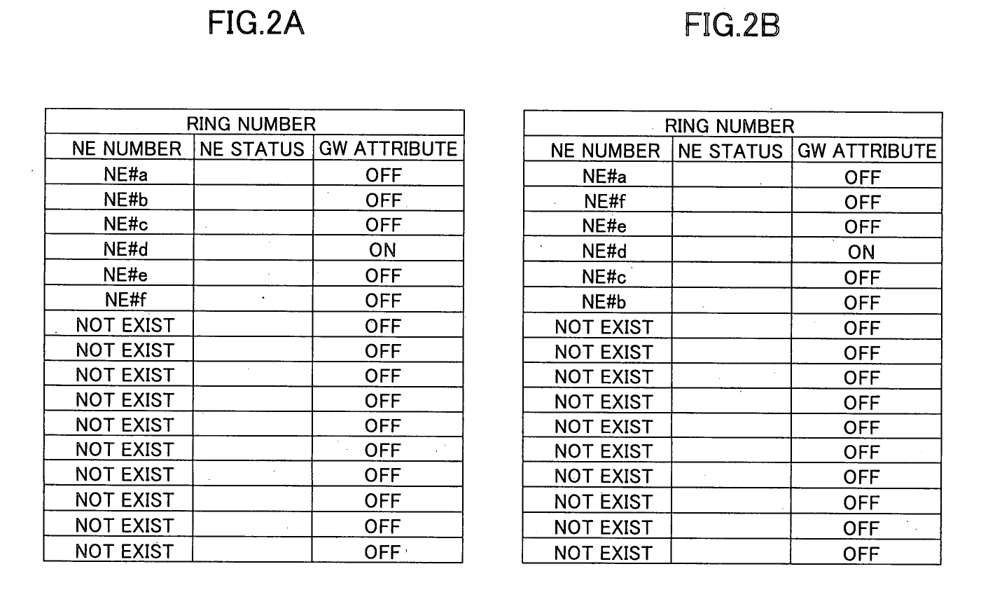

FIG. 3 is an exemplary flowchart of a conventional ring type network generation operation;

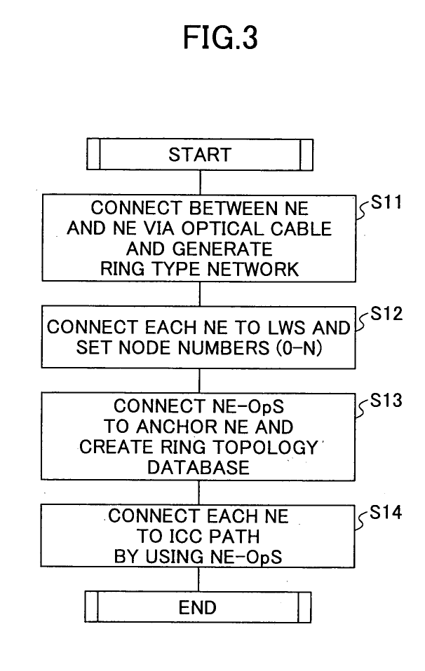

FIG. 4 is an exemplary flowchart of a conventional transmitter addition operation;

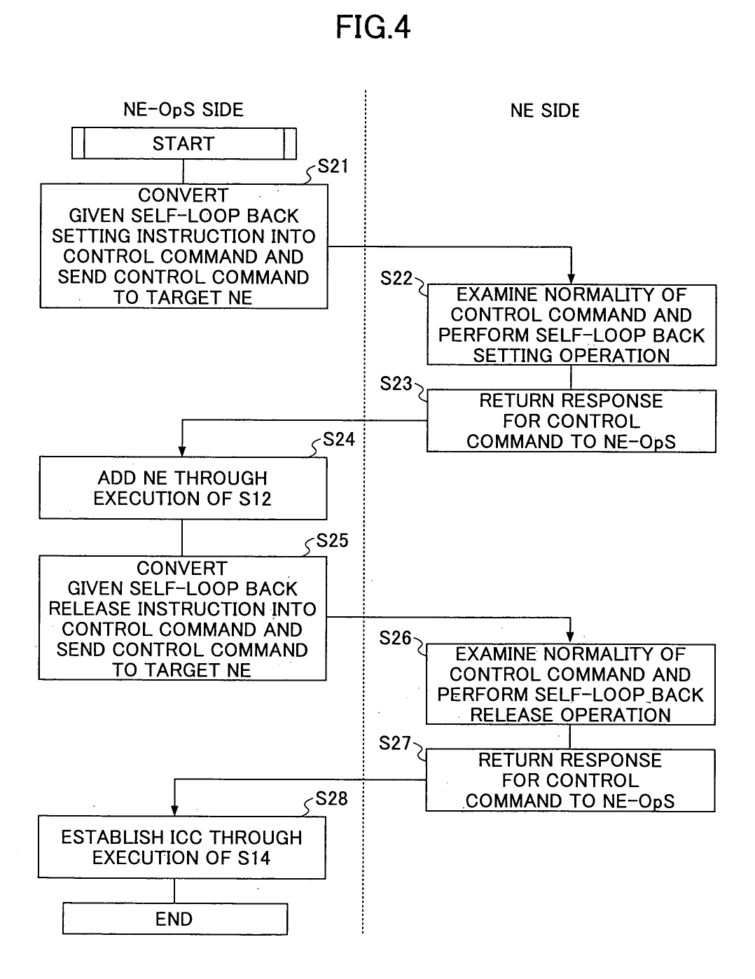

FIG. 5 is a diagram illustrating an exemplary frame structure of an OTN-OCh frame format of an optical digital wrapper;

FIG. 6 is a diagram illustrating an exemplary frame structure of a STM-1 frame format;

FIG. 7 is an exemplary SOH byte definition of a STM-1;

FIG. 8 is a diagram illustrating an exemplary structure of setting areas provided in OCh-PE according to a first embodiment of the present invention;

FIG. 9 is an exemplary flowchart of an available node number detection operation according to the first embodiment;

FIG. 10 is an exemplary flowchart of a set node number normality determination operation according to the first embodiment;

FIG. 11 is an exemplary flowchart of a topology data generation operation according to the first embodiment;

FIG. 12 is an exemplary flowchart of step S58 of the topology data generation operation according to the first embodiment;

FIG. 13 is a diagram to explain exemplary generation of topology data based on contents copied to a generic buffer;

FIG. 14 is an exemplary flowchart of a topology data distribution operation according to the first embodiment;

FIG. 15 is an exemplary flowchart of a topology data recovery operation according to the first embodiment;

FIG. 16 is a diagram illustrating an exemplary structure of setting areas provided in an empty DCC of SOH of an STM-1 frame format according to a second embodiment of the present invention;

FIG. 17 is a diagram to explain NE statuses and GW attributes of exemplary topology data according to the present invention; and

FIG. 18 is a diagram illustrating an exemplary structure of a transmitter according to the present invention.

### DETAILED DESCRIPTION OF THE PREFERRED EMBODIMENTS

In the following, embodiments of the present invention will be described with reference to the accompanying drawings.

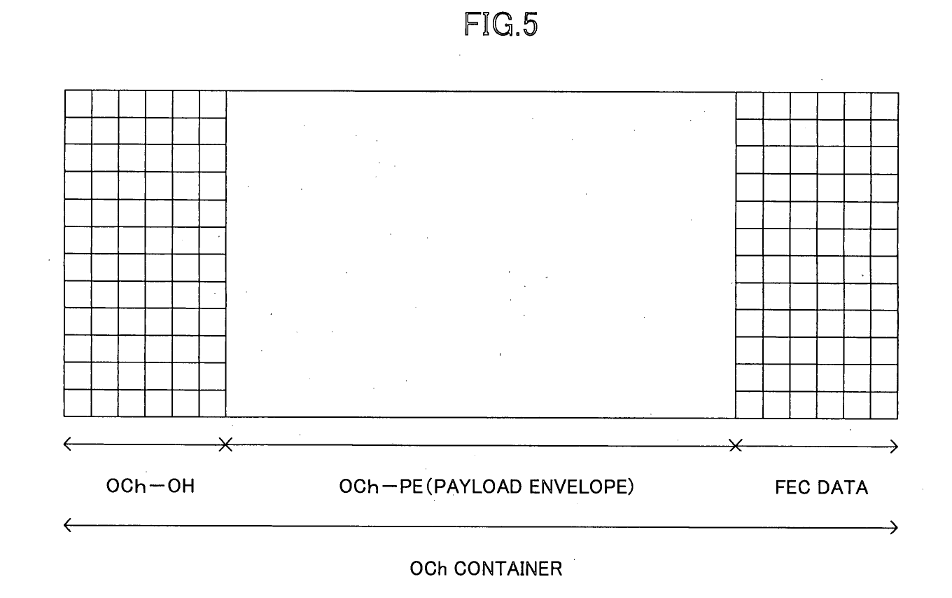

A description is given, with reference to FIG. 5 through FIG. 7, of a fundamental principle of the present invention.

As mentioned in the related art, since a plurality of transmitters 10a through 10f are distributed in a ring type network, the corresponding LWSs 14 are provided to assign node numbers to the individual transmitters 10a through 10f. However, the LWSs 14 do not necessarily share database that maintains the node numbers assigned to the transmitters 10a through 10f in the ring type network. For this reason, there is a problem in that an available node number cannot be determined in an on-demand fashion.

Also, the transmitters 10a through 10f cannot communicate each other in the ring type network until the monitor control operation system 12 establishes ICCs for the transmitters 10a through 10f. For this reason, there is another problem in that duplicated assignment of node numbers to the transmitters 10a through 10f cannot be observed.

In order to eliminate these problems, each of the transmitters 10a through 10f according to the present invention generates a packet that includes a setting area to set its own node number (self-node number). Then, node numbers assigned to the transmitters 10a through 10f are detected by circulating these packets in the ring type network.

As an embodiment of such a packet circulated in the ring type network, there is an OTN-OCh (Optical Transport Network-Optical Channel) frame format for an optical digital wrapper, to which those skilled in the art pay much attention for realization of high speed network routing. It will be known by those skilled in the art that the OTN-OCh frame format is recommended by ITU-T (International Telecommunication Union-Telecommunication Standardization Sector) G.709.

FIG. 5 shows an exemplary frame structure of an OTN-OCh frame format for an optical digital wrapper.

Referring to FIG. 5, when such an OTN-OCh frame format is used for an optical digital wrapper, each of the transmitters 10a through 10f prepares a setting area, which is for setting the self-node number, in a payload envelope (OCh-PE) of the OTN-OCh.

On the other hand, in a ring type network in which an optical digital wrapper is not supported, for example, a STM-1 (Synchronous Transport Module Level 1) frame according to TTC (Telecommunication Technology Committee) standard JT-G707 is available as an embodiment of a packet circulated in the ring type network.

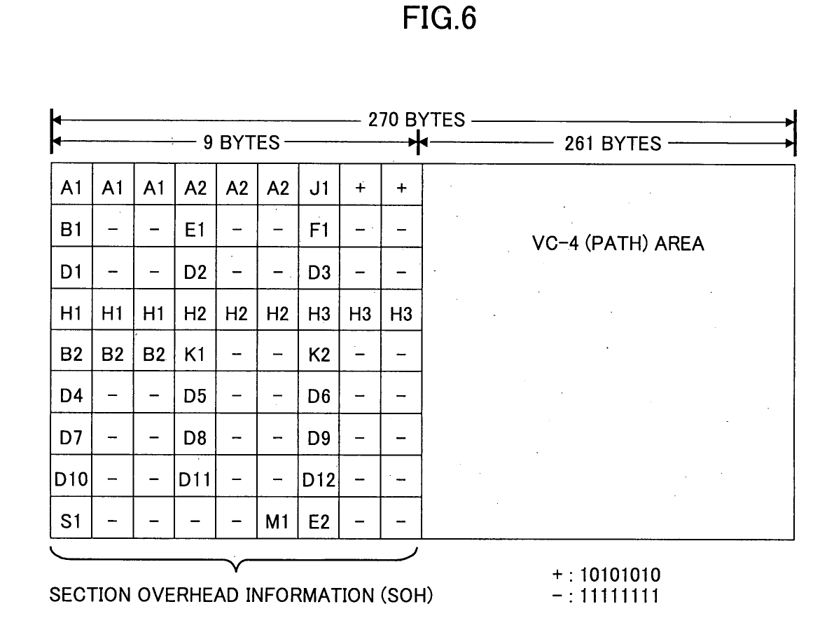

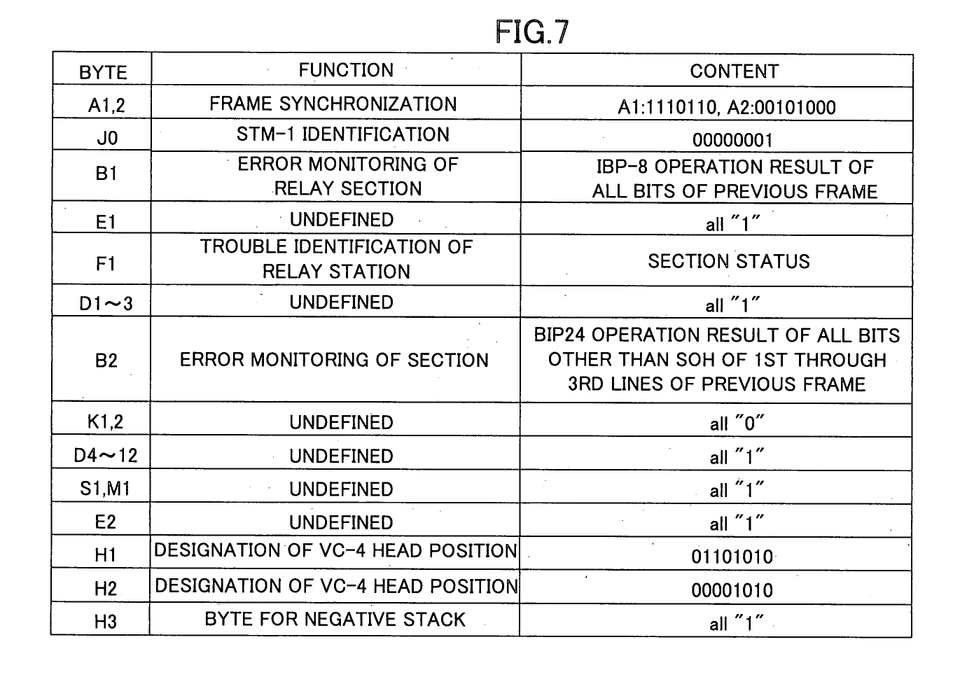

FIG. 6 shows an exemplary frame structure of a STM-1 frame format. FIG. 7 shows an exemplary SOH byte definition of a STM-1.

Referring to FIG. 6, when a STM-1 is used as a pcket, each of the transmitters 10a through 10f prepares a setting area, which is for setting the self-node number, in an available DCC (Data Communication Channel) of section overhead (SOH) information defined in the form of byte as illustrated in FIG. 7.

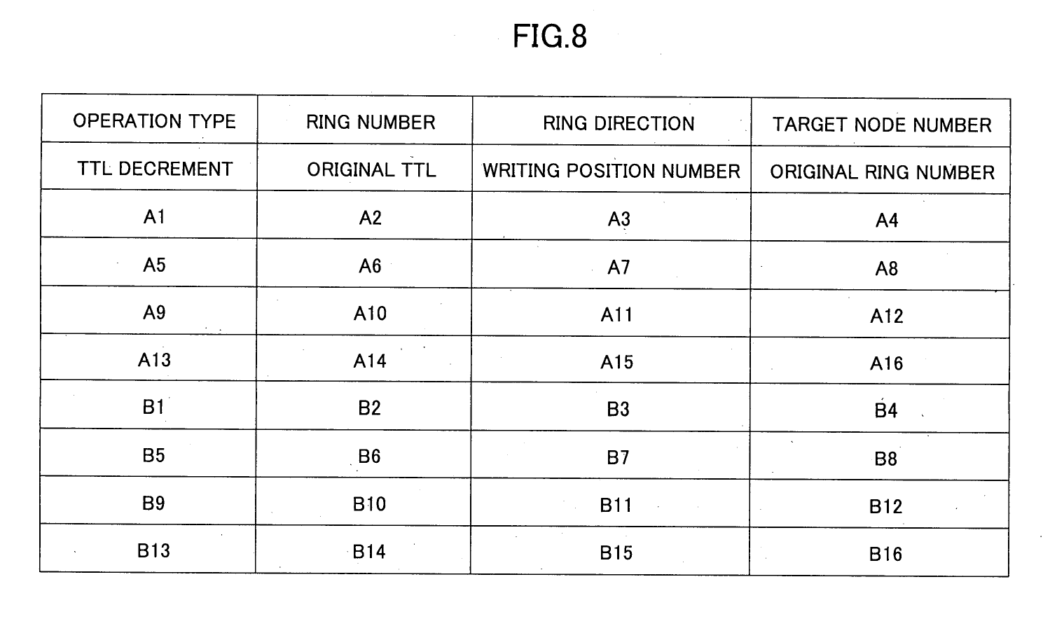

A description is given, with reference to FIG. 8 through FIG. 15, of a first embodiment of the present invention.

In the first embodiment, an OTN-OCh frame format for an optical digital wrapper is used as a packet circulated in a ring type network. By using such an OTN-OCh frame format, the transmitters 10a through 10f in the ring type network typically perform an available node number detection operation, a set node number normality determination operation, a topology data generation operation, a topology data distribution operation, and a topology data recovery operation to be described below.

FIG. 8 shows an exemplary structure of setting areas provided in OCh-PE according to the first embodiment.

Referring to FIG. 8, the setting areas comprise an operation type setting area, a ring number setting area, a ring direction setting area, a target node number setting area, a TTL (Time To Live) decrementing area, an original TTL setting area, a writing position number setting area, an original ring number setting area, non-packet source node number setting areas A1 through A16, and packet source node number setting areas B1 through B16.

In the operation type setting area, one of the available node number detection operation, the set node number normality determination operation, the topology data generation operation, the topology data distribution operation and the topology data recovery operation is set as an operation performed by the transmitters 10a through 10f.

In the ring number setting area, a ring number to identify a ring type network is set. For example, ring numbers 0 through 128 may be set in the ring number setting area.

In the ring direction setting area, an east directional transmission path or a west directional transmission path in a ring type network is set.

In the target node number setting area, a node number to designate one of the transmitters 10a through 10f is set.

In the TTL decrementing area, a value to be decremented is set. Whenever the packet passes through a gateway and others, the value is decremented by 1. When the decremented value reaches 0, the OTN-OCh frame is discarded to prevent a loop status.

In the original TTL setting area, an initial value in the TTL decrementing area is set.

In the writing position number setting area, locations, in which the transmitters 10a through 10f store the self-node numbers thereof, are set.

In the original ring number setting area, the ring number of a ring type network that initially issues the OTN-OCh frame packet is set.

In the non-packet source node number setting areas A1 through A16, the self-node numbers of transmitters that do not issue the OTN-OCh frame are set.

In the packet source node number setting areas B1 through B16, the self-node number of a transmitter that issues the OTN-OCh frame is set.

Each setting area shown in FIG. 8 may occupy at least one byte. Thus, at least 40 bytes are required to provide the setting areas in OCh-PE.

When the setting areas shown in FIG. 8 are provided in OCh-PE of an OTN-OCh frame, and such an OTN-OCh is circulated in a ring type network, it is possible to perform operations such as the available node number detection operation, the set node number normality determination operation, the topology data generation operation, the topology data distribution operation and the topology data recovery operation, as described in detail below.

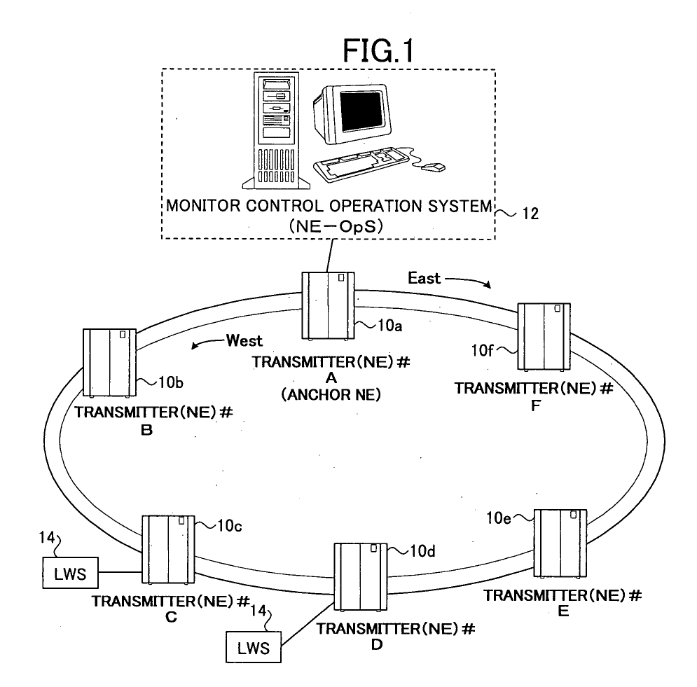

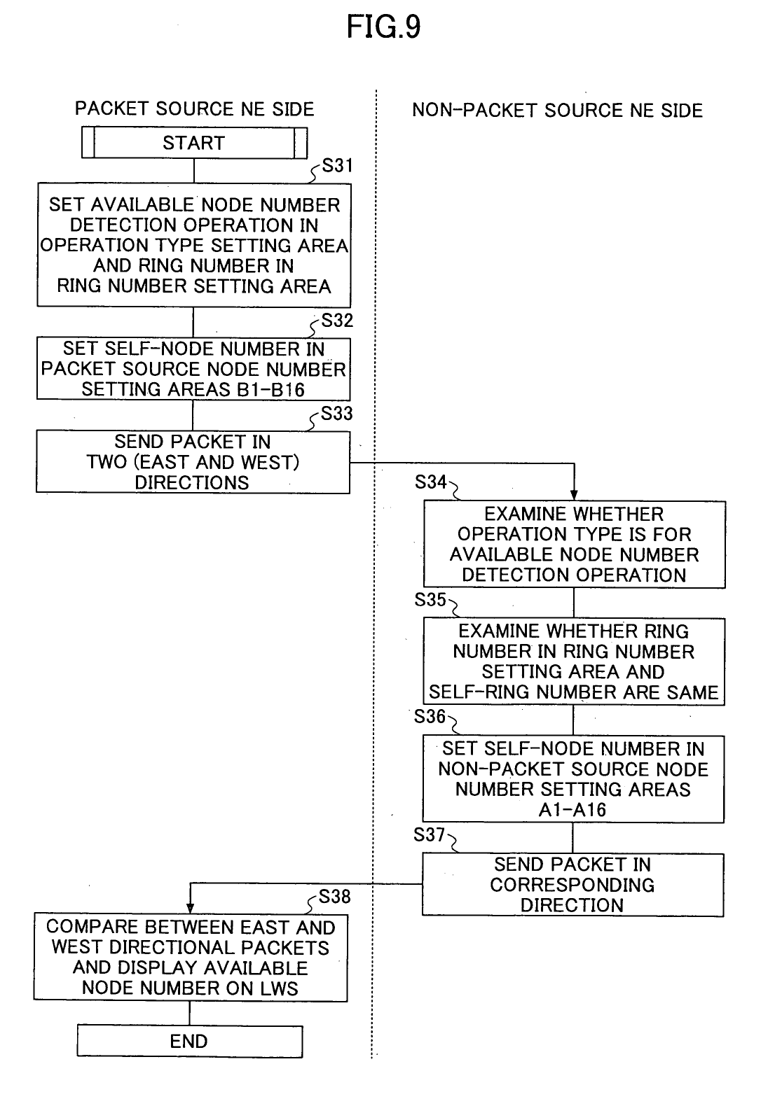

FIG. 9 is an exemplary flowchart of the available node number detection operation according to the first embodiment. In the following explanation, the transmitter 10a shown in FIG. 1 is supposed to perform the available node number detection operation.

Referring to FIG. 9, the transmitter 10a sets a value to indicate the available node number detection operation in the operation type setting area as well as the ring number of a ring type network, from which an available node number is expected to be detected, in the ring number setting area at step S31.

At step S32, the transmitter 10a sets the self-node number thereof in the packet source node number setting areas B1 through B16.

At step S33, the transmitter 10a sends an OTN-OCh frame (hereinafter which is simply referred to as a packet), in which the operation type setting area, the ring number setting area and the packet source node number setting areas B1 through B16 are set, to an east directional transmission path and a west directional transmission path.

When the packet is sent in the east direction, the packet is traversed in the ring type network in the order of transmitters 10a, 10f, 10e, 10d, 10c and 10b. On the other hand, when the packet is sent in the west direction, the packet is traversed in the ring type network in the order of the transmitters 10a, 10b, 10c, 10d, 10e and 10f.

At step S34, the transmitter 10f, in response to receipt of the east directional packet from the transmitter 10a, refers to the operation type setting area in OCh-PE of the packet. Here, the transmitter 10f is supposed to confirm that the value to indicate the available node number detection operation is set in the operation type setting area.

At step S35, the transmitter 10f refers to the ring number setting area in OCh-PE, and determines whether or not the ring number in the ring number setting area and the ring number of the ring type network to which the transmitter 10f belongs are the same. If the transmitter 10f determines that the two ring numbers are the same, the transmitter 10f moves to step S36. On the other hand, if the transmitter 10f cannot determine that the two ring numbers are the same, the transmitter 10f moves to step S37.

At step S36, the transmitter 10f sets the self-node number in the non-packet source node number setting areas A1 through A16 in OCh-PE, and then the transmitter 10f moves to step S37.

At step S37, the transmitter 10f sends the east directional packet received at step S34 in the east direction. Then, the transmitter 10e, in response to receipt of the east directional packet from the transmitter 10f, in turn, operates in accordance with the above-mentioned steps S34 through S37. Then, the transmitters 10d, 10c and 10b continuously perform the same operation.

On the other hand, the transmitters 10b, in response to receipt of the west directional packet from the transmitter 10a, performs steps S34 through S37 as in receipt of the east directional packet. Then, the transmitters 10c, 10d, 10e and 10f continuously perform the same operation.

As a result, when the east and west directional packets are circulated in the ring type network in the above fashion, the transmitter 10a eventually receives the packets. When the transmitter 10a receives the packets, the transmitter 10a moves to step S38.

At step S38, the transmitter 10a refers to the non-packet source node number setting areas A1 through A16 in OCh-PEs of the received packets. Then, the transmitter 10a examines which node number is not set in the non-packet source node number setting areas A1 through A16 with reference to the non-packet source node number setting areas A1 through A16 of OCh-PEs of the east and west directional packets, and determines a node number not set in the non-packet source node number setting areas A1 through A16 of both of the OCh-PEs as an available node number. Then, the transmitter 10a displays the available node number, for example, on a screen of LWS 14.

According to the available node number detection operation, it is possible to easily find an available node number, which is not assigned to transmitters in a ring type network, in an on-demand fashion.

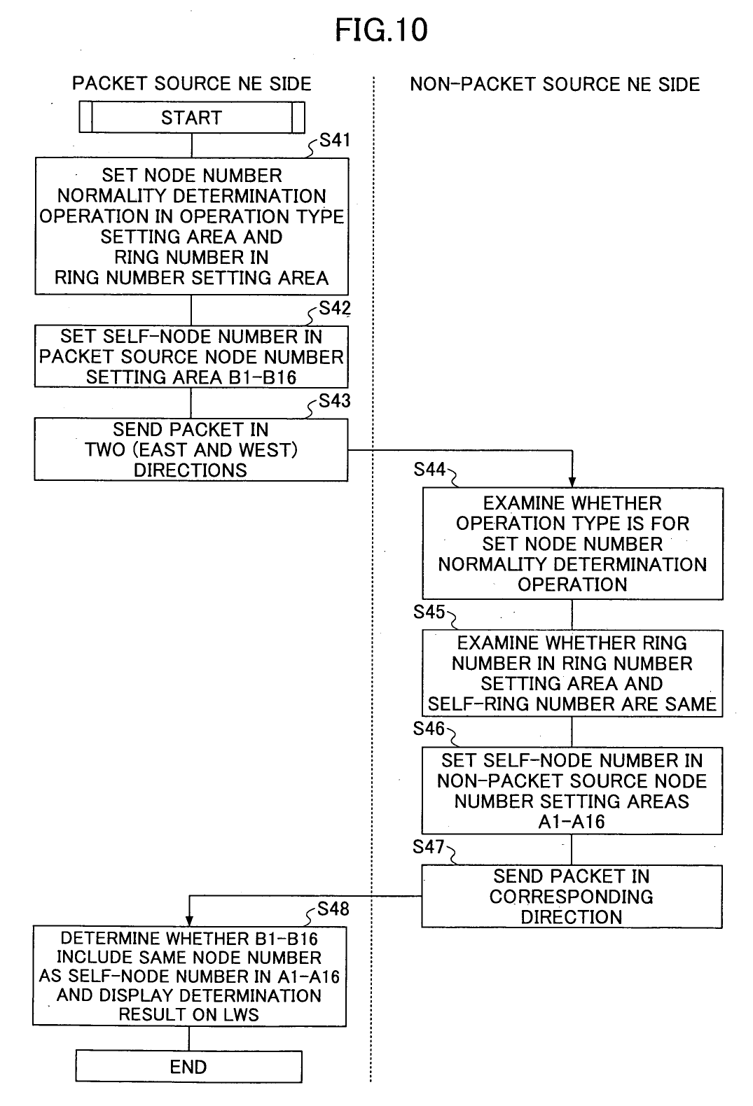

FIG. 10 is an exemplary flowchart of a set node number normality determination operation according to the first embodiment. In the following explanation, the transmitter 10a is supposed to perform the set node number normality determination operation.

Referring to FIG. 10, the transmitter 10a sets a value, for example, 2, to indicate the set node number normality determination operation in the operation type setting area and the ring number of a ring type network, which is expected to be determined whether or not the self-node number thereof is normal, in the ring number setting area at step S41.

At step S42, the transmitter 10a sets the self-node number thereof in the packet source node number setting areas B1 through B16.

At step S43, the transmitter 10a sends an OTN-OCh frame (hereinafter which is referred to as a packet), in which the operation type setting area, the ring number setting area and the packet source node number setting areas B1 through B16 are set, to an east directional transmission path and a west directional transmission path.

At step S44, the transmitter 10f, in response to receipt of the east directional packet from the transmitter 10a, refers to the operation type setting area in OCh-PE of the packet. Here, the transmitter 10f is supposed to confirm that the value to indicate the set node number normality determination operation is set in the operation type setting area.

At step S45, the transmitter 10f refers to the ring number setting area in the OCh-PE, and determines whether or not the ring number in the ring number setting area and the ring number of the ring type network to which the transmitter 10f belongs are the same. If the transmitter 10f determines that the two ring numbers are the same, the transmitter 10f moves to step S46.

On the other hand, if the transmitter 10f cannot determine that the two ring numbers are the same, the transmitter 10f moves to step S47.

At step S46, the transmitter 10f sets the self-node number in the non-packet source node number setting areas A1 through A16 in the OCh-PE, and then the transmitter 10f moves to step S47.

At step S47, the transmitter 10f sends the east directional packet received at step S44 in the east direction. Then, the transmitter 10e, in response to receipt of the east directional packet from the transmitter 10f, in turn, operates in accordance with the above-mentioned steps S44 through S47. Then, the transmitters 10d, 10c and 10b continuously perform the same operation.

On the other hand, the transmitters 10b, in response to receipt of the west directional packet from the transmitter 10a, performs steps S44 through S47 as in receipt of the east directional packet. Then, the transmitters 10c, 10d, 10e and 10f continuously perform the same operation.

As a result, when the east and west directional packets are circulated in the ring type network, the transmitter 10a eventually receives the packets. When the transmitter 10a receives the east and west directional packets, the transmitter 10a moves to step S48.

At step S48, the transmitter 10a refers to the non-packet source node number setting areas A1 through A16 and the packet source node number setting areas B1 through B16 in the OCh-PEs of the received packets. Then, the transmitter 10a determines whether or not the packet source node number setting areas B1 through B16 include the same node number as the self-node number of the transmitter 10a in the non-packet source node number setting areas A1 through A16.

If the transmitter 10a determines that the packet source node number setting areas B1 through B16 do not include the same node number as the self-node number of the transmitter 10a in the non-packet source node number setting areas A1 through A16, the transmitter 10a determines that the self-node number thereof is normal.

On the other hand, if the transmitter 10a determines that the packet source node number setting areas B1 through B16 include the same node number as the self-node number of the transmitter 10a in the non-packet source node number setting areas A1 through A16, the transmitter 10a determines that the self-node number thereof is not normal.

Then, the transmitter 10a displays on a screen of LWS 14 results of the determination whether the self-node number thereof is unique in the ring type network, that is, is not duplicated in the ring type network.

According to the set node number normality determination operation, it is possible to easily determine whether or not a self-node number of a transmitter is uniquely assigned in a ring type network.

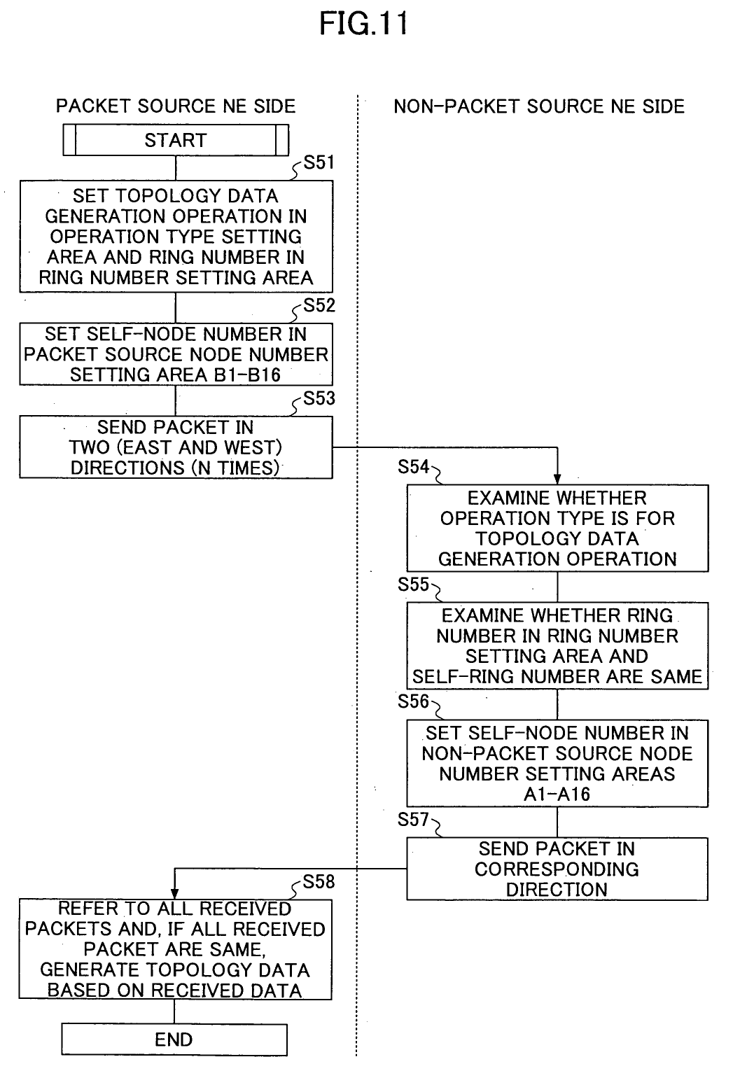

FIG. 11 is an exemplary flowchart of a topology data generation operation according to the first embodiment. In the following explanation, the transmitter 10a is supposed to perform the topology data generation operation.

Referring to FIG. 11, the transmitter 10a sets a value, for example, 3, to indicate the topology data generation operation in the operation type setting area and the ring number of a ring type network, for which topology data are expected to be generated, in the ring number setting area at step S51.

At step S52, the transmitter 10a sets the self-node number thereof in the packet source node number setting areas B1 through B16.

At step S53, the transmitter 10a sends an OTN-OCh frame (hereinafter which is referred to as a packet), in which the operation type setting area, the ring number setting area and the packet source node number setting areas B1 through B16 are set, to an east directional transmission path or a west directional transmission path.

At step S54, the transmitter 10f, in response to receipt of the east directional packet from the transmitter 10a, refers to the operation type setting area in OCh-PE of the received packet. Here, the transmitter 10f is supposed to confirm that the value to indicate the topology data generation operation is set in the operation type setting area.

At step S55, the transmitter 10f refers to the ring number setting area in the OCh-PE, and determines whether or not the ring number in the ring number setting area and the ring number of a ring type network to which the transmitter 10f belongs are the same. If the transmitter 10f determines that the two ring numbers are the same, the transmitter 10f moves to step S56.

On the other hand, if the transmitter 10f cannot determine that the two ring numbers are the same, the transmitter 10f moves to step S57.

At step S56, the transmitter 10f sets the self-node number in the non-packet source node number setting areas A1 through A16 in the OCh-PE, and then the transmitter 10f moves to step S57.

At step S57, the transmitter 10f sends the east directional packet received at step S54 in the east direction. Then, the transmitter 10e, in response to receipt of the east directional packet from the transmitter 10f, operates in accordance with the above-mentioned steps S54 through S57. Then, the transmitters 10d, 10c and 10b continuously perform the same operation.

On the other hand, the transmitters 10b, in response to receipt of the west directional packet from the transmitter 10a, performs steps S54 through S57 as in receipt of the east directional packet.

As a result, when the east and west directional packets are circulated in the ring type network, the transmitter 10a eventually receives the packets. In the topology data generation operation, the transmitter 10a iteratively performs steps S51 through S53 predetermined times, for example, N times. Thus, the transmitter 10a eventually receives the N east directional packets and the N west directional packets at step S58.

If all the received packets are the same, the transmitter 10a generates topology data based on the received packets. On the other hand, if all the received packets are not the same, the transmitter 10a does not generate topology data.

However, even in the case where all the received packets are not the same, for example, if the proportion of the same packets to all the received packets is above a predetermined ratio, the transmitter 10a may generate topology data.

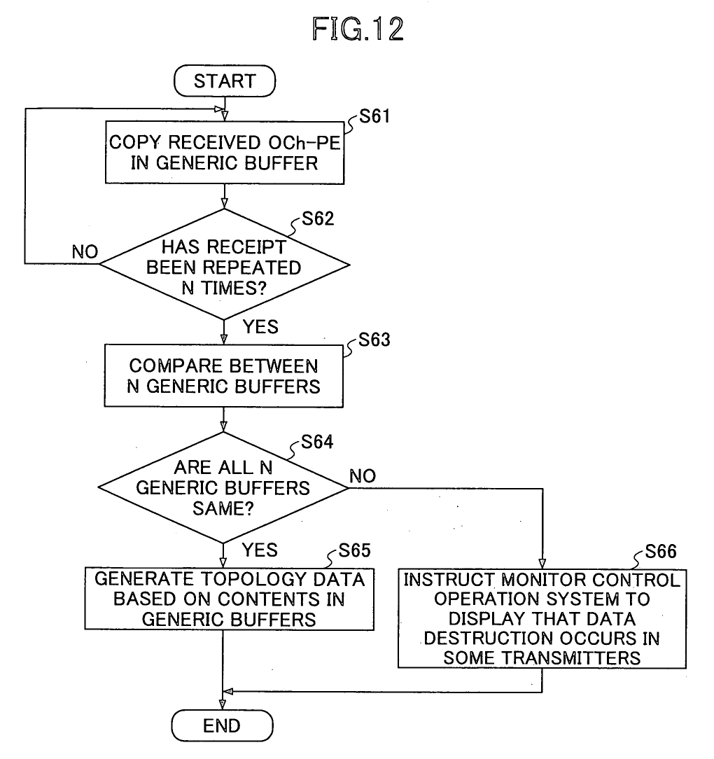

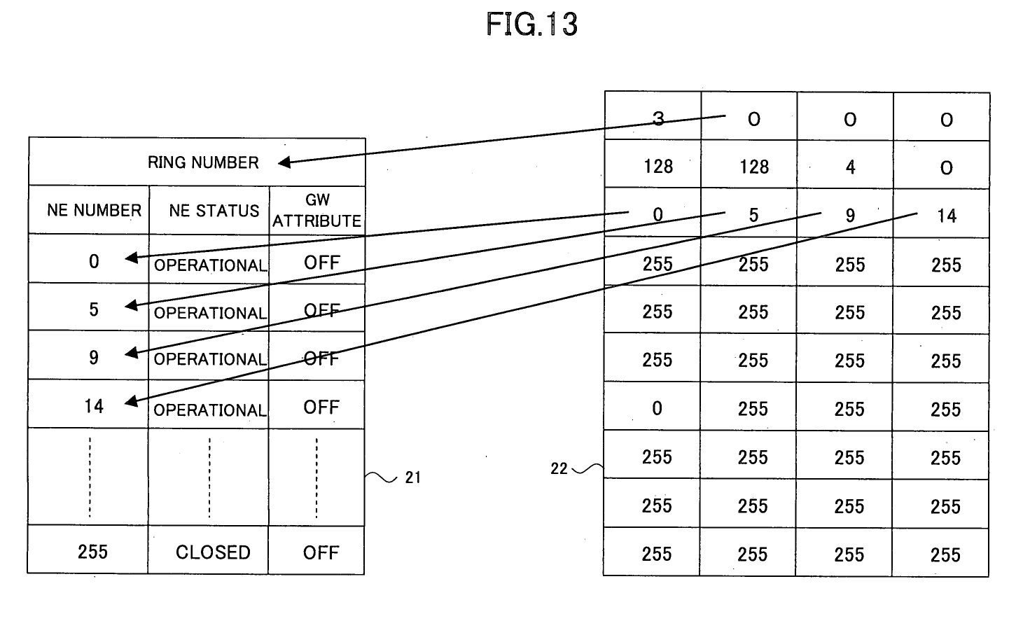

In the following, step S58 is explained in detail with reference to FIG. 12 and FIG. 13.

FIG. 12 is an exemplary flowchart of step S58 of the topology data generation operation according to the first embodiment.

Referring to FIG. 12, the transmitter 10a reads contents of the setting areas from each of the received packets, and copies the contents to a generic buffer at step S61.

At step S62, the transmitter 10a determines whether or not the receipt of the east directional packets and the west directional packets has been repeated N times. If the transmitter 10a determines that the receipt has not been repeated N times (S62: NO), the transmitter 10a returns to step S61. On the other hand, if the transmitter 10a determines that the receipt has been repeated N times (S62: YES), the transmitter 10a moves to step S63.

At step S63, the transmitter 10a compares between the setting areas copied to N generic buffers. If the transmitter 10a determines that the copied contents in the N generic buffers are the same (S64: YES), the transmitter 10a moves to step S65. On the other hand, if the transmitter 10a determines that the copied contents in the N generic buffers are not the same (S64: NO), the transmitter 10a moves to step S66.

At step S65, the transmitter 10a selects one of the contents copied to the N generic buffers, and generates topology data based on the selected contents. Then, the topology data generation operation is terminated.

At step S66, the transmitter 10a instructs the monitor control operation system 12 to display the fact that data destruction occurs in some of the transmitters 10a through 10f.

FIG. 13 is a diagram to explain exemplary generation of topology data based on contents copied to a generic buffer.

Referring to FIG. 13, topology data 21 and setting areas 22 are provided. In the setting areas 22, the ring number is set as 0, the ring direction is set as the east direction (0), the node number 0 is set as the anchor NE, and the node numbers 0, 5, 9 and 14 are assigned to NEs such that these NEs are disposed in the order with respect to the east direction. It is noted that the setting areas are given in the same format as that shown in FIG. 8.

The topology data 21 are generated based on the contents copied from the setting areas 22 to a generic buffer, as illustrated by the arrows in FIG. 13. For example, the contents “0, 5, 9, 14” in the non-packet source node number setting areas are reflected to the node numbers (NE numbers) of the topology data 21.

According to the topology data generation operation, it is possible to detect node numbers assigned to transmitters in a ring type network and generate topology data regarding the ring type network easily.

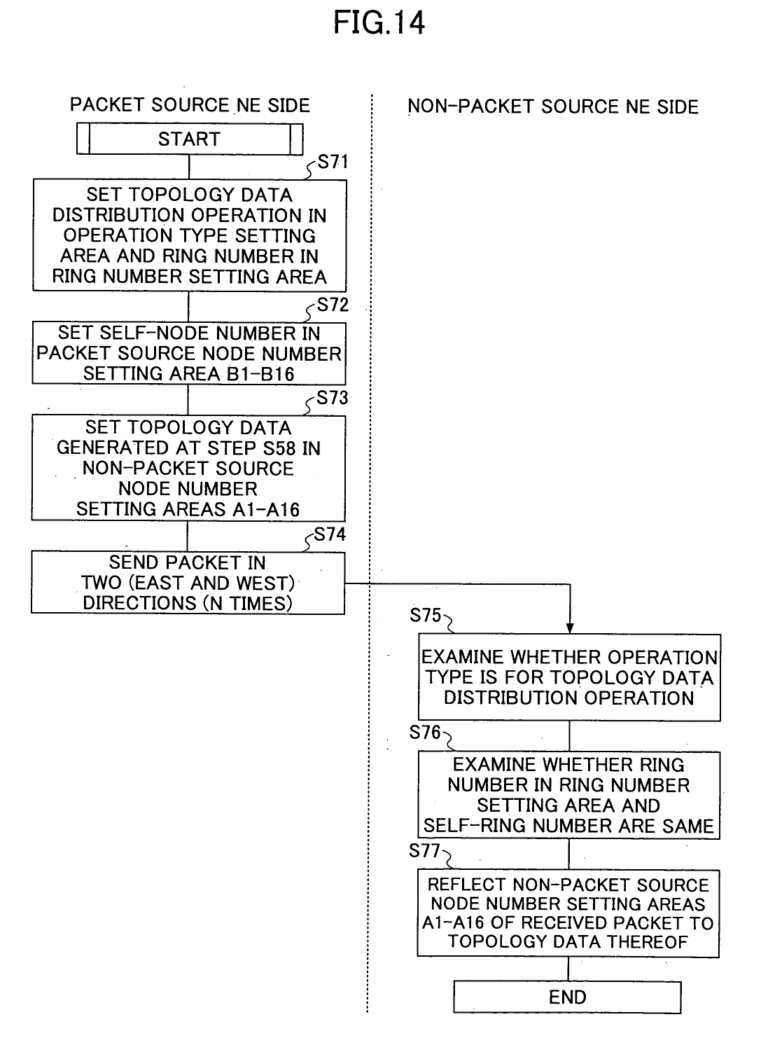

FIG. 14 is an exemplary flowchart of a topology data distribution operation according to the first embodiment. In the following, the transmitter 10a is supposed to perform the topology data distribution operation.

Referring to FIG. 14, the transmitter 10a sets a value, for example, 4, to indicate the topology data distribution operation in the operation type setting area and the ring number of a ring type network, to which topology data are expected to be distributed, in the ring number setting area at step S71.

At step S72, the transmitter 10a sets the self-node number thereof in the packet source node number setting areas B1 through B16.

At step S73, the transmitter 10a sets node numbers (NE numbers) of the topology data, as generated at step S58, in the non-packet source node number setting areas A1 through A16.

At step S74, the transmitter 10a sends an OTN-OCh frame (hereinafter which is referred to as a packet), in which the operation type setting area, the ring number setting area, the packet source node number setting areas B1 through B16 and the non-packet source node number setting areas A1 through A16 are set, to an east directional transmission path and a west directional transmission path.

At step S75, the transmitter 10f, in response to receipt of the east directional packet from the transmitter 10a, refers to the operation type setting area in OCh-PE of the received packet. Here, the transmitter 10f is supposed to confirm that the value to indicate the topology data distribution operation is set in the operation type setting area.

At step S76, the transmitter 10f refers to the ring number setting area in the OCh-PE, and determines whether or not the ring number in the ring number setting area and the ring number of a ring type network to which the transmitter 10f belongs are the same. If the transmitter 10f determines that the two ring numbers are the same, the transmitter 10f moves to step S77.

At step S77, the transmitter 10f reflects contents in the non-packet source node number setting areas A1 through A16 in the OCh-PE to topology data that the transmitter 10f posseses. On the other hand, if the transmitter 10f cannot determine that the two ring numbers are the same, the transmitter 10f does not perform step S77.

Then, the transmitter 10f sends the received east directional packet in the east direction. Then, the transmitter 10e, in response to receipt of the east directional packet from the transmitter 10f, operates in accordance with the above-mentioned steps S75 through S77. Then, the transmitters 10d, 10c and 10b continuously perform the same operation.

On the other hand, the transmitters 10b, in response to receipt of the west directional packet from the transmitter 10a, performs steps S75 through S77 as in receipt of the east directional packet. Then, the transmitters 10c, 10d, 10e and 10f continuously perform the same operation.

According to the topology data distribution operation, it is possible to easily distribute topology data.

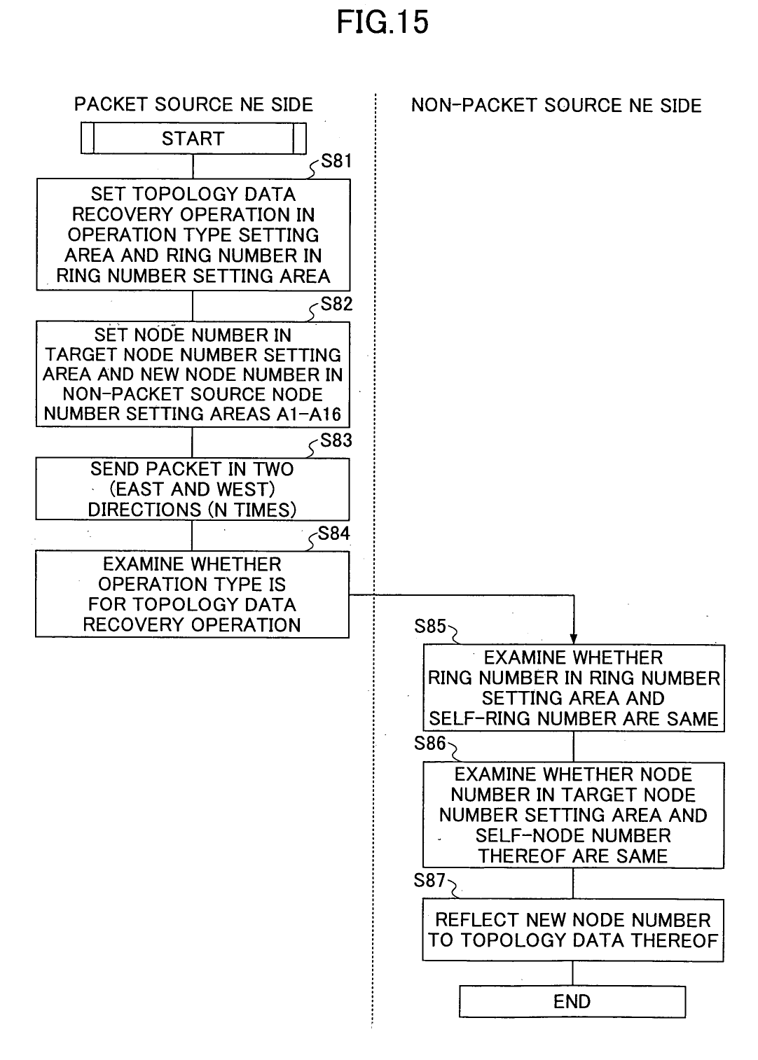

FIG. 15 is an exemplary flowchart of a topology data recovery operation according to the first embodiment. In the following, the transmitter 10a is supposed to perform the topology data recovery operation.

Referring to FIG. 15, the transmitter 10a sets a value, for example, 5, to indicate the topology data recovery operation in the operation type setting area and the ring number of a ring type network, for which topology data are expected to be recovered, in the ring number setting area at step S81.

At step S82, the transmitter 10a sets a target node number in the target node number setting area and an alternate new node number in the non-packet source node number setting areas A1 through A16.

At step S83, the transmitter 10a sends an OTN-OCh frame (hereinafter which is referred to as a packet), in which the operation type setting area, the ring number setting area, the target node number setting area and the non-packet source node number setting areas A1 through A16 are set, to an east directional transmission path and a west directional transmission path.

At step S84, the transmitter 10f, in response to receipt of the east directional packet from the transmitter 10a, refers to the operation type setting area in OCh-PE of the received packet. Here, the transmitter 10f is supposed to confirm that the value to indicate the topology data recovery operation is set in the operation type setting area.

At step S85, the transmitter 10f refers to the ring number setting area in OCh-PE, and determines whether or not the ring number in the ring number setting area and the ring number of a ring type network to which the transmitter 10f belongs are the same. If the transmitter 10f determines that the two ring numbers are the same, the transmitter 10f moves to step S86.

At step S86, the transmitter 10f determines whether or not the node number in the target node number setting area and the self-node number thereof are the same. If the transmitter 10f determines that the two node numbers are the same, the transmitter 10f moves to step S87.

At step S87, the transmitter 10f reflects the new node number in the non-packet source node number setting areas A1 through A16 in the OCh-PE to topology data that the transmitter 10f possesses. On the other hand, if the transmitter 10f cannot determine that the two ring numbers are the same at step 85, the transmitter 10f does not perform step S87. Also, if the transmitter 10f cannot determine that the node numbers are the same at step S86, the transmitter 10f does not perform step S87.

Then, the transmitter 10e, in response to receipt of the east directional packet from the transmitter 10f, operates in accordance with the above-mentioned steps S84 through S87. Then, the transmitters 10d, 10c and 10b continuously perform the same operation.

On the other hand, the transmitters 10b, in response to receipt of the west directional packet from the transmitter 10a, performs steps S84 through S87 as in receipt of the east directional packet. Then, the transmitters 10c, 10d, 10e and 10f continuously performs the same operation.

According to the topology data recovery operation, it is possible to easily recover topology data.

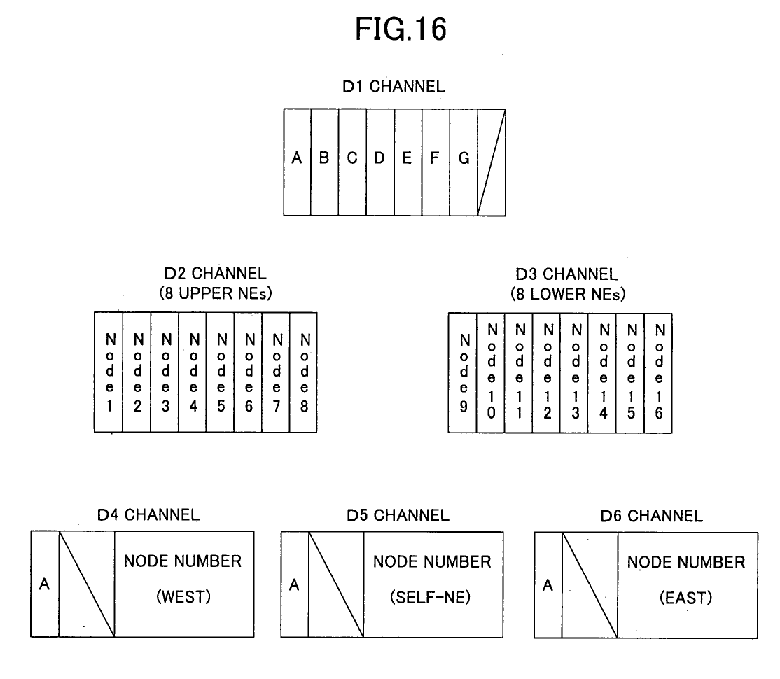

A description is given, with reference to FIG. 16, of a second embodiment of the present invention.

In the second embodiment, a STM-1 frame format based on TTC standard JT-G707 is used as a packet circulated in a ring type network. By using such an STM-1 frame format, the transmitters 10a through 10f typically performs an available node number detection operation, a set node number normality determination operation and a topology data generation operation to be described below.

FIG. 16 shows an exemplary structure of setting areas provided in empty DCCs (Digital Communication Channel) of SOH (Section OverHead) of an STM-1 frame format according to the second embodiment. In the setting areas shown in FIG. 16, undefined bytes D1 through D6 of SOH are used.

Referring to FIG. 16, the byte D1 comprises a ring direction setting bit A, an available node number detection operation flag bit B, a set node number normality determination operation flag bit C, a node number duplication detection operation flag bit D, a topology data generation operation flag bit E, a topology data update request bit F and a node number duplication notification bit G.

The bytes D2 and D3 comprise bits to represent validity of the node numbers 1 through 16. For example, if the node number 1 is assigned to a transmitter in a ring type network, the corresponding bit of the bytes D2 and D3 is set as 1. In other words, bits of the bytes D2 and D3 represent available node numbers in the ring type network.

The byte D4 comprises a topology data validity bit A, and a bit to indicate the node number of a transmitter adjacent in the west direction. The byte D5 comprises a topology data validity bit A and a bit to indicate the self-node number. The byte D6 comprises a topology data validity bit A and a bit to indicate the node number of a transmitter adjacent in the east direction.

According to the second embodiment, when the same operations as those of the first embodiment are performed, the setting areas shown in FIG. 16 are provided in empty DCC channels of SOH of an STM-1 frame format and the STM-1 packet is circulated in a ring type network. As a result, it is possible to properly perform the available node number detection operation, the set node number normality determination operation and the topology data generation operation as in those of the first embodiment.

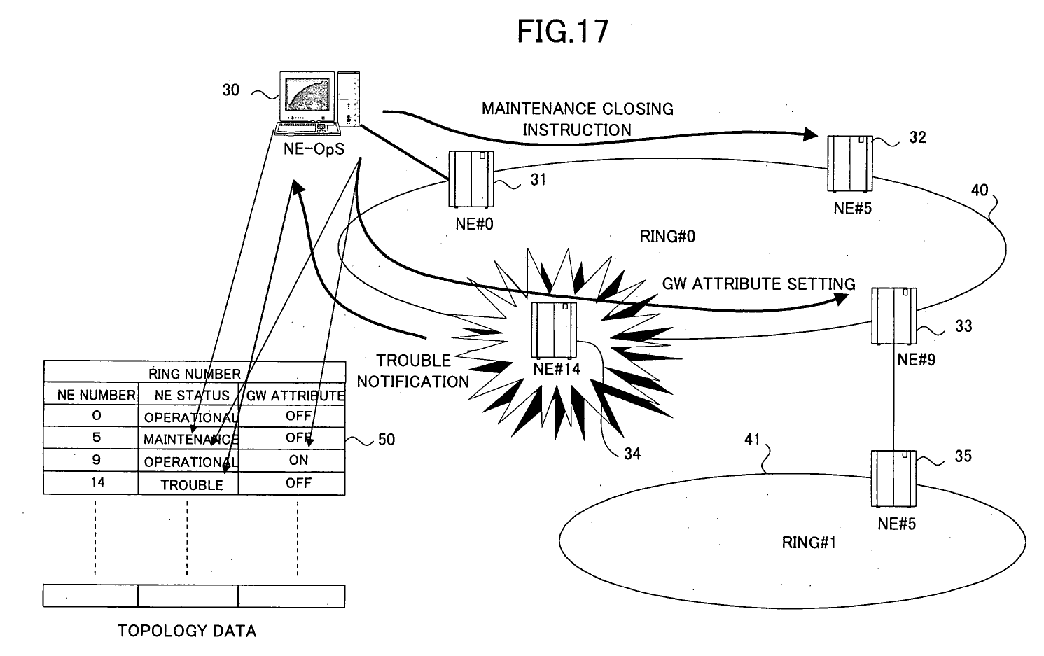

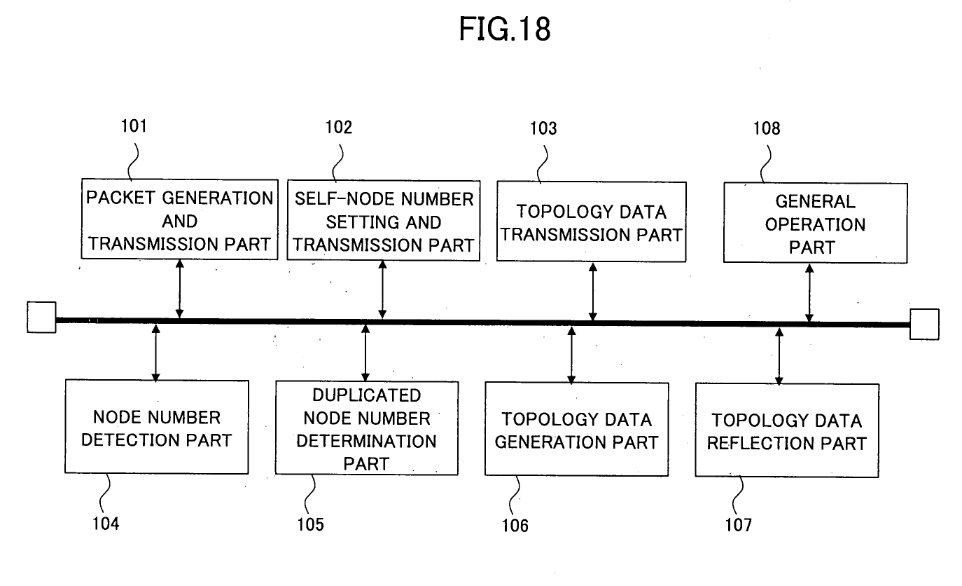

A description is given, with reference to FIG. 17 and FIG. 18, of topology data and transmitters according to the present invention.

FIG. 17 is a diagram to explain NE statuses and GW attributes of exemplary topology data according to the present invention.

Referring to FIG. 17, a transmitter 31 of the node number 0, a transmitter 32 of the node number 5, a transmitter 33 of the node number 9 and a transmitter 34 of the node number 14 are connected in a ring type network 40 of the ring number 0. Also, a transmitter 35 of the node number 5 is connected in another ring type network 41 of the ring number 1.

In this illustration, the transmitter 31 is used as an anchor NE and is connected to a monitor control operation system (NE-OpS) 30. Also, the transmitter 33 in the ring type network 40 is connected to the transmitter 35 in the ring type network 41.

Here, it is supposed that the transmitter 34 becomes unavailable due to some trouble and informs the monitor control operation system 30 of the trouble. Also, the monitor control operation system 30, in response to receipt of the trouble notification from the transmitter 34, issues maintenance closing instruction to the transmitter 32. The illustrated topology data 50 represents this circumstance.

It is noted that transmitters 10a through 10f according to the present invention can be configured as illustrate in FIG. 18.

FIG. 18 shows an exemplary structure of a transmitter according to the present invention.

Referring to FIG. 18, the transmitter comprises a packet generation and transmission part 101, a self-node number setting and transmission part 102, a topology data transmission part 103, a node number detection part 104, a duplicated node number determination part 105, a topology data generation part 106, a topology data reflection part 107 and an general operation part 108 to perform fundamental operations of the transmitter.

The packet generation and transmission part 101 performs steps S31 through 33, S41 through S43, and S51 through S53.

The self-node number setting and transmission part 102 performs steps S34 through S37 and S44 through S47.

The topology data transmission part 103 performs steps S71 through S74 and S81 through S83.

The node number detection part 104 operates corresponding to step S38.

The duplicated node number determination part 105 performs step S48.

The topology data generation part 106 performs step S58.

The topology data reflection part 107 performs steps S75 through S77 and S84 through S87.

According to a ring type network including the above-mentioned transmitter, since the ring type network allows detection of an available node number and generation of topology data, it is possible to more conveniently maintain and operate the ring type network with fewer operation steps to improve a maintenance and operation speed of the ring type network.

The present invention is not limited to the specifically disclosed embodiments, and variations and modifications may be made without departing from the scope of the present invention.

What is claimed is:

1. A transmitter connected to a ring type network, comprising:
a packet generation and transmission part generating a packet to cause at least one other transmitter in the ring type network to set a node number assigned to the at least one other transmitter in the packet, and circulating said packet in the ring type network; and
a node number detection part, in response to receipt of the circulated packet, reading at least one node number set by the at least one other transmitter from the packet and detecting an available node number that is not assigned to the at least one other transmitter with reference to the at least one read node number.

2. The transmitter as claimed in claim 1, further comprising a self-node number setting and transmission part, in response to receipt of the packet generated by another transmitter in the ring type network, setting a self-node number of the transmitter in the packet and sending the packet to another transmitter in the ring type network.

3. The transmitter as claimed in claim 2, wherein:
the self-node number setting and transmission part reads a ring number to identify the ring type network from the received packet;
when the ring number and a ring number of a ring type network to which the transmitter belongs are the same, the self-node number setting and transmission part sets the self-node number in the packet and sends the packet to the another transmitter; and
on the other hand, when the ring number and the ring number of the ring type network to which the transmitter belongs are not the same, the self-node number setting and transmission part sends the packet to the another transmitter without setting the self-node number in the packet.

4. A transmitter connected to a ring type network, comprising:
a packet generation and transmission part generating a packet to cause at least one other transmitter in the ring type network to set a node number assigned to the at least one other transmitter in the packet and circulating said packet in the ring type network; and
a duplicated node number detection part, in response to receipt of the circulated packet, reading at least node number set by the at least one other transmitter from the packet and determining whether or not any of the at least one read node number and a self-node number of the transmitter are the same.

5. The transmitter as claimed in claim 4, further comprising a self-node number setting and transmission part, in response to receipt of the packet generated by another transmitter in the ring type network, setting a self-node number of the transmitter in the packet and sending the packet to another transmitter in the ring type network.

6. The transmitter as claimed in claim 5, wherein:
the self-node number setting and transmission part reads a ring number to identify the ring type network from the received packet;
when the ring number and a ring number of a ring type network to which the transmitter belongs are the same, the self-node number setting and transmission part sets the self-node number in the packet and sends the packet to the another transmitter; and
on the other hand, when the ring number and the ring number of the ring type network to which the transmitter belongs are not the same, the self-node number setting and transmission part sends the packet to the another transmitter without setting the self-node number in the packet.

7. A transmitter connected to a ring type network, comprising:
a packet generation and transmission part generating a packet to cause at least one other transmitter in the ring type network to set a node number assigned to the at least one other transmitter in the packet and circulating said packet in the ring type network; and
a topology data generation part, in response to receipt of the circulated packet, reading at least one node number set by the at least one other transmitter from the packet and generating topology data regarding the ring type network based on the at least one node number.

8. The transmitter as claimed in claim 7, further comprising:
a topology data transmission part generating a packet including the generated topology data and circulating the packet in the ring type network; and
a topology data reflection part, in response to receipt of the packet, reading the topology data from the packet and reflecting the topology data to a database of the transmitter.

9. The transmitter as claimed in claim 8, wherein the topology data reflection part:
reads a target node number from the packet; and
when the target node number and a self-node number of the transmitter are the same, reads the topology data from the packet and reflects the topology data to the database.

10. The transmitter as claimed in claim 8, wherein the topology data reflection part:
reads a ring number to identify the ring type network from the received packet; and
when the ring number and a ring number of a ring type network to which the transmitter belongs are the same, reads the topology data from the packet and reflects the topology data to the database.

11. A method of detecting an available node number that is not assigned to any of at least one transmitter in a ring type network, the method comprising the steps of:
generating a packet to cause the at least one transmitter in the ring type network to set a node number assigned to the at least one other transmitter in the packet and circulating said packet in the ring type network; and
reading, in response to receipt of the circulated packet, at least one node number set by the at least one transmitter from the packet and detecting the available node number with reference to the at least one read node number.

12. A method of determining whether there is an duplicated node number in a ring type network, the method comprising the steps of:
generating a packet to cause at least one transmitter in the ring type network to set a node number assigned to the at least one transmitter in the packet and circulating said packet in the ring type network; and
reading, in response to receipt of the circulated packet, at least node number set by the at least one transmitter from the packet and determining whether or not any of the at least one read node number and any of at least one self-node number of the at least one transmitter are the same.

13. A method of generating topology data regarding a ring type network including at least one transmitter, the method comprising the steps of:
generating a packet to cause the at least one transmitter in the ring type network to set a node number assigned to the at least one transmitter in the packet and circulating said packet in the ring type network; and
reading, in response to receipt of the circulated packet, at least one node number set by the at least one transmitter from the packet and generating the topology data regarding the ring type network based on the at least one node number.
